(19) United States
(12) Patent Application Publication
(10) Pub. No.: US 2010/0310165 A1
(43) Pub. Date: Dec. 9, 2010

(54) IMAGE RESTORATION METHOD AND APPARATUS

(75) Inventors: Po-Chang Chen, Taipei County (TW); Chir-Weei Chang, Taoyuan County (TW); Chuan-Chung Chang, Hsinchu County (TW); Ludovic Angot, Hsinchu City (TW); Chih-Hao Liu, Taichung City (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/792,712

(22) Filed: Jun. 2, 2010

(30) Foreign Application Priority Data
Jun. 9, 2009 (TW) TW098119242

(51) Int. Cl. G06K 9/40

(52) U.S. Cl. 382/167; 382/260; 382/255

(57) ABSTRACT

An image restoration method is disclosed. The method is used in an image restoration apparatus and configured to restore an image captured by an imaging system. The method includes capturing a scenery image by the imaging system and applying restoration processing to the scenery image using a plurality of restoration filters respectively corresponding to a plurality of depths, to generate a plurality of restored images respectively corresponding to the depths.

### CROSS REFERENCE TO RELATED APPLICATIONS

This Application claims priority of Taiwan Patent Application No. 098119242, filed on 9 Jun. 2009, the entirety of which is incorporated by reference herein.

### BACKGROUND

1. Technical Field

The disclosure relates to an image restoration method and apparatus for images captured by imaging systems or cameras.

2. Description of the Related Art

Demand for improved image quality of digital cameras has continued to increase along with increasing digital camera usage. However, image quality continues to be hindered by lens manufacturing limitation and nonlinear characteristics and noise found in a sensor.

Generally, the point spread function (PSF) can be used to represent an imaging system (or an optical channel). Given a fixed image plane, a point light source at an object distance will be imaging onto the image plane through the imaging system to form a point spread function. At each object distance, the imaging system has a corresponding point spread function to characterize its optical channel response. In most applications with incoherent illuminations, the imaging system is assumed to be linear and hence, a final image of an object captured by an imaging system with a sensor can be computed from convoluting the object image and the point spread function characterizing the imaging system for the object distance at which the object is placed.

Simply, an object under an object distance can form an image segment on the sensor via the convolution computation described above, while a scenery including several objects can give an image composing of image segments of the objects. Owing to the PSF varying with the object distance, if the objects are at different object distances, their corresponding image segments will have different amounts of blur. When a point spread function is approximately equal to an optimum impulse function or the size of the point spread function is smaller than a pixel of the sensor, an image formed on the sensor can be called an optimum image. In reality, the point spread function is enlarged due to diffraction limit, aberration, and so on. Thus, even if the imaging system is focused on a target object, the object image cannot be perfectly formed on the sensor and, to other objects at distances beyond the depth of field, their image quality seriously degraded due to defocus.

With respect to applications regarding monitor apparatuses, video apparatuses, or general cameras, a focusing mechanism or an autofocus device is required to capture clear object images for different object distances, thereby adjusting focus planes by moving lenses. However, the mechanism of the autofocus device is complicated such that the cost for a camera equipped with the device is difficult to be reduced. Additionally, using a moving component, such as a piezoelectric actuator or a voice coil motor may hasten wear of the camera.

As described, a varifocal lens or an auto-focusing lens is commonly used in traditional cameras. The varifocal lens moves a specified lens to change focus and adjusts the focal plan to the distance of a target object. The auto-focusing lens additionally uses a range finding unit or an image analyzing algorithm for focusing. Both the varifocal lens and the auto-focusing lens adjust the focal length which is inconvenient and time-consuming for manual adjustment and increase production costs to be with an actuator (such as the piezoelectric actuator or the voice coil motor) and a range finding unit for automatic adjustment.

U.S. Patent Pub. No. 2007/0230944 discloses a plenoptic camera (or named Adobe Light-Field Camera), used for producing an integral view. The disclosure divided a lens into multiple sub-lenses (or named micro-lenses), wherein each sub-lens provides different focal lengths. The sub-lenses are used to capture images in different fields and then information of the captured images are used to re-calculate focused images according to the target objects or target object distances. The patent can produce multiple images with different focus under one shot and can also perform refocusing to interesting objects or object distances. However, an image sensor with great size and substantially more pixels is desirable in the prior art.

### SUMMARY

An exemplary embodiment of an image restoration method configured to restore an image captured by an imaging system, comprises capturing a scenery image by the imaging system; and applying a restoration processing to the scenery image using a plurality of restoration filters respectively corresponding to a plurality of depths, to generate a plurality of restored images respectively corresponding to the depths.

Another exemplary embodiment of an image restoration method used in an image restoration apparatus and configured to restore an image captured by an imaging system, comprises retrieving channel information of the imaging system; calculating a plurality of restoration filters respectively corresponding to a plurality of depths according to the channel information; capturing a scenery image by the imaging system; and applying a restoration processing to the scenery image using the restoration filters to generate a plurality of restored images respectively corresponding to the depths.

Another exemplary embodiment of an image restoration method used in an image restoration apparatus and configured to restore an image captured by an imaging system, comprises retrieving first image information of a test pattern; retrieving plural pieces of second image information generated by capturing the test pattern, using the imaging system, under a plurality of depths; calculating a plurality of restoration filters according to the first image information and the pieces of second image information; capturing a scenery image by the imaging system; and applying a restoration processing to the scenery image using the restoration filters to generate a plurality of restored images respectively corresponding to the depths.

An exemplary embodiment of an image restoration apparatus configured to apply a restoration processing to a scenery image captured by an imaging system, comprises a storage unit configured to store a plurality of sets of filter parameters respectively corresponding to different depths; and at least one computation unit coupled to the storage unit and configured to load the sets of the filter parameters from the storage unit and apply a restoration processing to the scenery image respectively according to the sets of the filter parameters to generate a plurality of restored images respectively corresponding to different depths.

Another exemplary embodiment of an image restoration apparatus configured to apply a restoration processing to a scenery image captured by an imaging system, comprises a filter computation module configured to capture channel information of the imaging system and calculate a plurality of sets of filter parameters respectively corresponding different depths according to the channel information; a storage unit coupled to the filter computation module and configured to store the sets of the filter parameters; and at least one computation unit coupled to the storage unit, configured to load the sets of the filter parameters corresponding to the depths from the storage unit and apply a restoration processing to the scenery image according to the sets of the filter parameters to generate a plurality of restored images respectively corresponding to the depths.

Another exemplary embodiment of an image restoration apparatus configured to apply a restoration processing to a scenery image captured by an imaging system, comprises a filter computation module configured to capture original first image information of a test pattern, capture plural pieces of second image information generated by capturing the test pattern, using the imaging system, under a plurality of depths, and calculate a plurality of sets of filter parameters respectively corresponding to the depths according to the first image information and the pieces of second image information; a storage unit coupled to the filter computation module and configured to store the sets of the filter parameters; and at least one computation unit coupled to the storage unit and configured to load the sets of the filter parameters from the storage unit and apply a restoration processing to the scenery image according to the sets of the filter parameters to generate a plurality of restored images respectively corresponding to the depths.

An exemplary embodiment of a computer-readable medium encoded with computer executable instructions for performing an image restoration method used in an image restoration apparatus and configured to restore an image captured by an imaging system, wherein the computer executable instructions comprise capturing a scenery image by the imaging system; and applying a restoration processing to the scenery image using a plurality of restoration filters respectively corresponding to a plurality of depths, to generate a plurality of restored images respectively corresponding to the depths.

Another exemplary embodiment of a computer-readable medium encoded with computer executable instructions for performing an image restoration method used in an image restoration apparatus and configured to restore an image captured by an imaging system, wherein the computer executable instructions comprise retrieving first image information of a test pattern; retrieving plural pieces of second image information generated by capturing the test pattern, using the imaging system, under a plurality of depths; calculating a plurality of restoration filters respectively corresponding to the depths according to the first image information and the pieces of second image information; capturing a scenery image by the imaging system; and applying a restoration processing to the scenery image using the restoration filters to generate a plurality of restored images respectively corresponding to the depths.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a schematic view of image restoration for an image generated by an imaging system using a restoration filter;

FIGS. 2A and 2B are schematic views of image restoration of the disclosure;

FIG. 3A is a schematic view of a first embodiment of an image restoration apparatus of the disclosure;

FIG. 3B is a schematic view of the first embodiment of an image restoration apparatus with internally installed restoration filters of the disclosure;

FIG. 4 is a schematic view of a first embodiment of an image restoration method of the disclosure;

FIG. 5 is a schematic view of a second embodiment of an image restoration apparatus of the disclosure;

FIG. 6 is a schematic view of a second embodiment of an image restoration method of the disclosure;

FIG. 7 is a schematic view of a third embodiment of an image restoration apparatus of the disclosure;

FIG. 8 is a schematic view of a third embodiment of an image restoration method of the disclosure;

FIG. 9 is a schematic view of a fourth embodiment of an image restoration apparatus of the disclosure;

FIG. 10 is a schematic view of the fourth embodiment of a test pattern of the disclosure;

FIG. 11 is a schematic view of a fourth embodiment of an image restoration method of the disclosure;

FIG. 12 is a schematic view of a fifth embodiment of an image restoration apparatus of the disclosure;

FIG. 13 is a schematic view of the fifth embodiment of a filter computation module of the disclosure;

FIG. 14 is a schematic view of the fifth embodiment of a test pattern of the disclosure;

FIG. 15 is a schematic view of a fifth embodiment of an image restoration method of the disclosure; and

FIG. 16 is a schematic view of a computer-readable medium of the disclosure.

### DETAILED DESCRIPTION

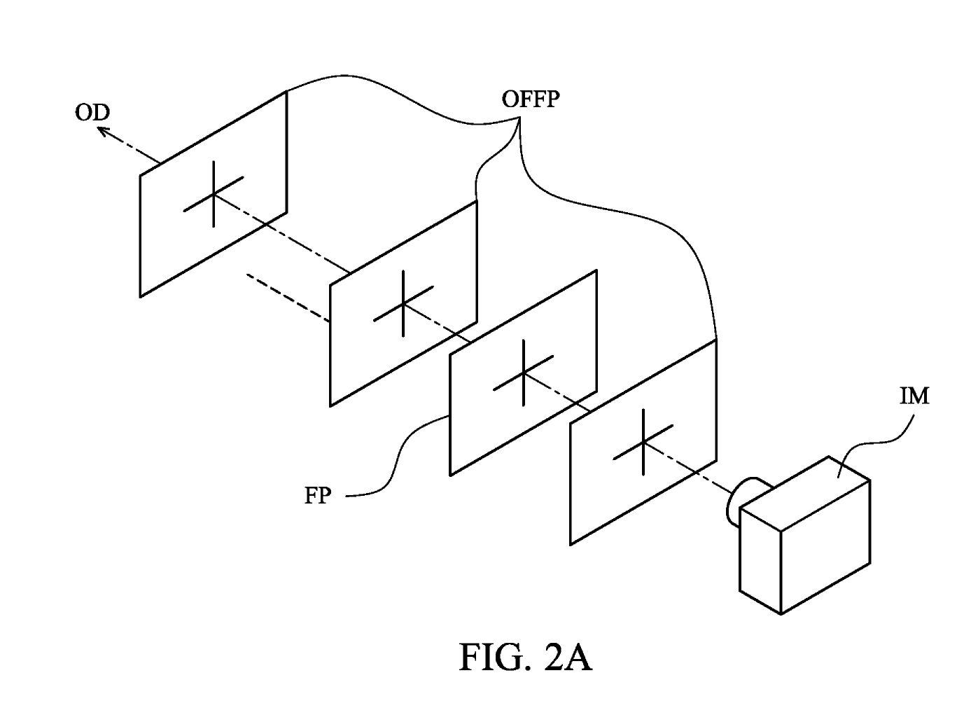

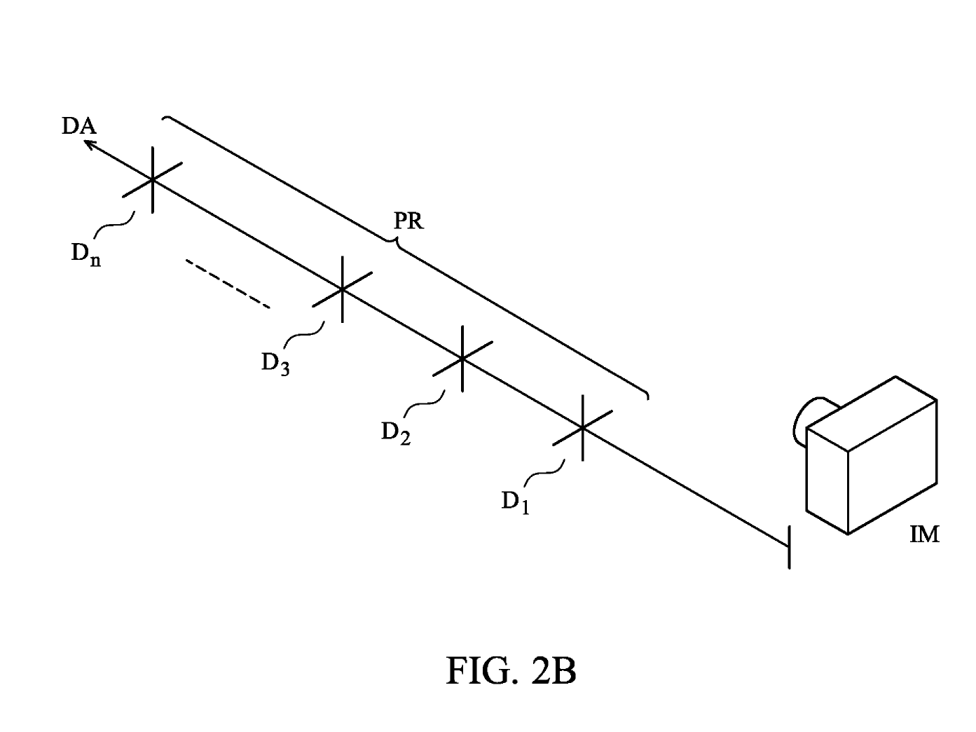

Several exemplary embodiments of the disclosure are described with reference to FIGS. 2A through 16, which generally relate to image restoration for multiple object distances. It is to be understood that the following disclosure provides various different embodiments as examples for implementing different features of the disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The disclosure discloses an image restoration method and apparatus.

An embodiment of the image restoration method and apparatus, employing filters, applies image restoration processing to an image captured by an imaging system. Each filter contains a set of parameters, which is designed according to the channel information, such as PSF or optical transfer function (OTF), of the imaging system corresponding to a specific object distance, and the filter is used for coping with image blur resulted from the imperfect PSF of the imaging system with respect to the object distance. When one filter designed for one object distance is applied to an image captured by the imaging system, the image segment of the object originally placed at the object distance will be restored to be sharp and clear. If the filters are designed for distinct object distances and being applied to the image, the filters can produce a plurality of restored images, each with image segments of objects with respect to the corresponding object distance to be sharp and clear.

Further, the design can be one filter kernel with multiple sets of parameters. By choosing a proper set of the parameters applying to images captured by the imaging system, the focal plane (or clear image plane) corresponding to an object distance can be equivalently shifted to a target object distance specified by the parameters. An exemplary embodiment can be the surveillance camera or image capturing device, the object distance of the clear image plane can be changed by means of switching the filter parameters

The described channel information used for designing the filter parameters can be represented as a PSF or an OTF of an imaging system. The filter parameters can also be calculated according to digital image information of a test pattern (digital values of image pixel array, for example) and digital image information obtained by shooting the test pattern with an imaging system.

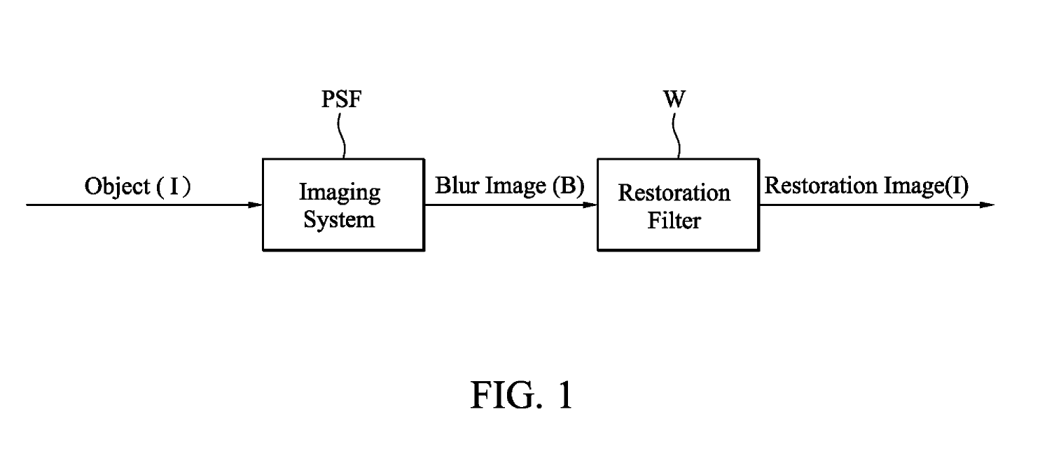

FIG. 1 is a schematic view of image restoration for an image generated by an imaging system using a restoration filter.

As shown in FIG. 1, assume that an optical transfer function of the imaging system 110 is represented as H_{f}=F{H}, where H represents the point spread function. The Fourier Transform for an input image I and the output image B of the imaging system 110 is represented as I_{f}=F{I} and B_{f}=F{B} respectively. Then the B_{f} can be calculated by

B_{f}=H_{f}I_{f} (f1).

The restoration filter processes a received image, that is, the output image B_{f}, using equation (f2), represented as:

Î_{f}=B_{f}W_{f} (f2),

where W_{f}=F{W} represents a restoration filter.

Ideally, if W_{f}=H_{f}⁻¹, then (f1) and (f2) give Î_{f}=I_{f} and F⁻¹{I_{f}}=I. Here W_{f} is called the inverse filter. The inverse filter can be also transformed to spatial domain and perform restoration processing as:

Î=B*W (f3),

where * represents convolution.

However, in general, the PSF information (H) or the OTF information (H_{f}) of the imaging system cannot be accurately obtained or the its parameters may be affected by lens manufacturing error, non-linear characteristics of sensors, and so on, so that the inverse filter can not be designed without accurate channel information. Meanwhile, since most optical channels possess low pass characteristics, the inverse filter equalizes the optical channels by amplifying high-frequency input signals. However, such high frequency amplification processes also amplify noise or interference at high frequencies. Thus, if significant noise is introduced in the imaging system, restoration performance may be seriously degraded and the output image quality would be unacceptable.

FIGS. 2A and 2B are schematic views of image restoration of the disclosure. In these figures, the imaging system (IM) can be equipped a fixed focal lens or a varifocal lens in any focus adjustment. Referring to FIG. 2A, when the imaging system IM or a camera is used to shoot a scene and produce a scene image, it is known that the image segments associated with the objects, in the scene, under an object distance (OD, also named a depth hereafter) are blurred by a PSF corresponding to the object distance. If the OFFP represents the out-of-focal plane and FP represents the focal plane, the objects at or near the FP will produce clear image segments while those at the OFFP will generate blur image segments due to defocus. We can divide a range of object distance into several depths and each depth is associated with a plane perpendicular to the OD axis as the FP or OFFP in FIG. 2A. Here we name the range processing range (PR) and label the depths D₁, D₂, . . . , Dₙ.

Referring to FIG. 2B, the PR and depth 1 (D₁) to depth n (Dₙ) are shown in the figure. The DA represents the depth axis, which is equivalent to the OD axis in FIG. 2A. Without considering occlusion, an object placed at depth Dₖ and shot by the IM generates an image segment Bₖ. Assuming that an ideal in-focus image segment of the object is Iₖ and the point spread function of the imaging system with respect to depth Dₖ is Hₖ, Bₖ can be computed by:

Bₖ=Hₖ*Iₖ (f4),

To restore the blur image segment Bₖ caused by Hₖ, a restoration filter (or a set of parameters) Wₖ can be designed and applied to B to have an estimate Îₖ:

Îₖ=Wₖ*Bₖ=Wₖ*(Hₖ*Iₖ) (f5),

so that Îₖ→Iₖ.

Regarding different depths D₁˜Dₙ, embodiments of the disclosure provides restoration filters W₁˜Wₙ to restore the image segments corresponding to the objects located at depths D₁˜Dₙ, respectively. In reality, a scene to be shot may comprise multiple objects located at different depths, and thus the scene image contains several object segments with different amounts of blur. Suppose that B is an image captured by the IM and contains several image segments of objects. When the disclosure applies a filter Wₖ, for kε(1, 2, . . . , n), to the captured image B, the image segments associated with the objects at depth Dₖ will be restored. Applying filters W₁, W₂, . . . , Wₙ one by one to the image B can produce n restored images respectively with clear image segments corresponding to D₁, D₂, . . . , Dₙ. For example, applying filter W₁ to image B generates a restored image with clear image segments for depth D₁, applying filter W₂ to image B generates a restored image with clear image segments for depth D₂, and so forth.

Note that a scenery image used in the image restoration method and apparatus is a two-dimensional image, which can also be a three-dimensional image information.

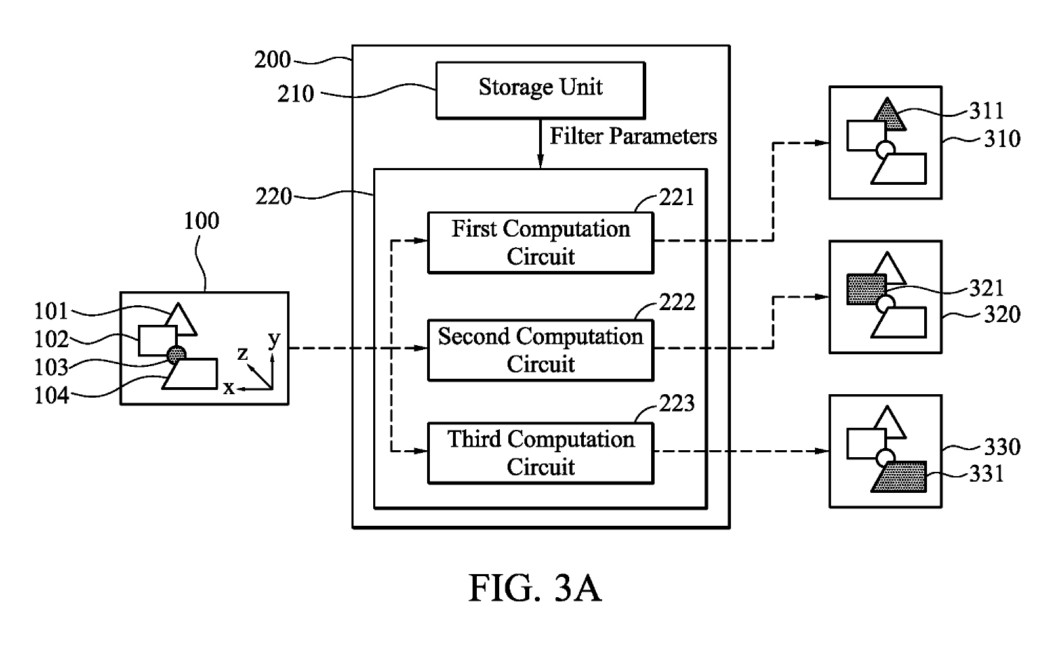

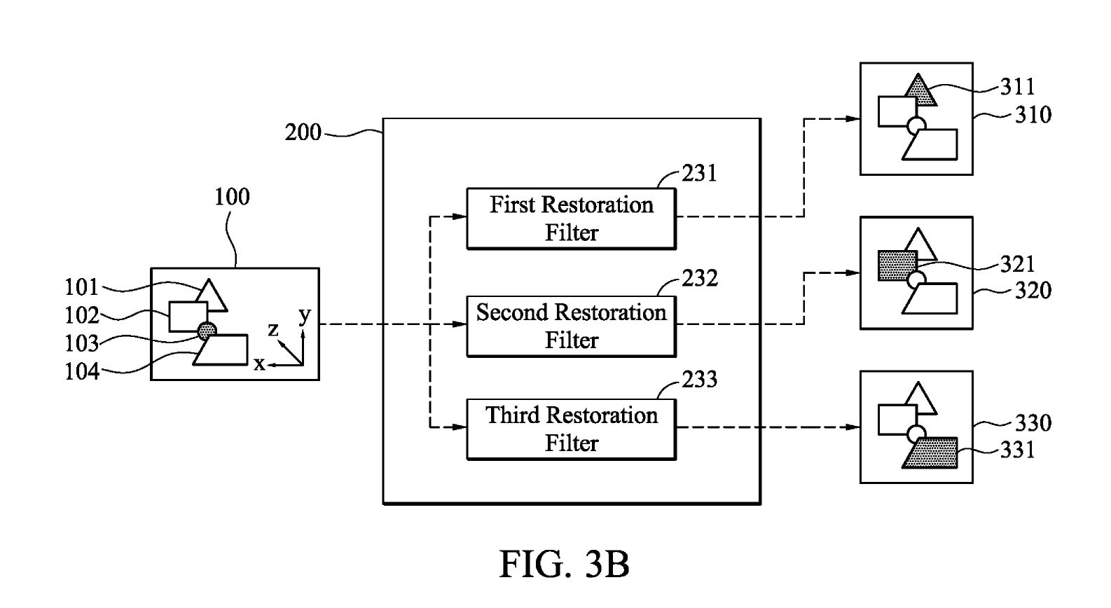

FIG. 3A is a schematic view of a first embodiment of an image restoration apparatus of the disclosure.

An image 100 captured by an imaging system (not shown) comprises image segments 101, 102, 103, and 104 respectively located at different depths, wherein only the image segment 103 is focused (i.e. located in the focal plane) while the image segments 101, 102, and 104 are defocused and blurred (i.e. located in the out-of-focus planes). The image restoration apparatus 200 comprises a storage unit 210 and a computation unit 220. The storage unit 210 internally stores three sets of filter parameters designed for the imaging system and used to restore image segments for three distinct depths. For simplification, assume that the objects 101, 102, and 104 are originally located at the three depths whose corresponding three image segments are capable of being restored using three computation circuits (or filter kernels) respectively with the three sets of filter parameters.

The computation unit 220 comprises a first computation circuit 221, a second computation circuit 222, and a third computation circuit 223, which can respectively load the three sets of filter parameters in the storage unit 210 and perform restoration processing to input images. Since one set of the filter parameters is designed for restoration processing for one of the three depths, only one image segment, 101, 102 or 104, will be restored by one computation circuit with its correspondent set of filter parameters. That is to say, the first computation circuit 221 performs a restoration processing to generate a restored image 310, wherein the (restored) image segment 311 is a restored one of the image segment 101. Similarly, the second computation circuit 222 and the third computation circuit 223 perform restoration processing to generate restored images 320 and 330, wherein the (restored) image segments 321 and 331 are restored image segments of 102 and 104 respectively.

By using the image restoration apparatus of the first embodiment, a plurality of restored images respectively corresponding to different depths can be obtained.

Note that, for simplification, the first embodiment restores the three out-of-focus image segments using the three sets of filter parameters corresponding to the three depths. In reality, however, the storage unit 210 may comprise multiple sets of parameters and the computation unit 200 may comprise multiple computation circuits for restoration of the input image with respect to multiple depths.

Note that the design of filter parameters is not the technical feature of the disclosure and they can be computed using prior methods, so details thereof are not described herein. Further, there may be more than one set of filter parameters for one depth to achieve different amounts of signal enhancement.

Note that, in an embodiment, the restoration filter can be implemented by hardware in a structure as shown in FIG. 3B. The image restoration apparatus 200 contains three restoration filters 231, 232 and 233. Each restoration filter comprises a computation circuit with a set of the filter parameter for restoration processing of one depth. For simplicity, in this embodiment, assume that the three objects respectively associating to the image segments 101, 102, and 104 are originally located at the three depths for which the three sets of the filter parameters respectively corresponding to the restoration filters 231, 232 and 233 are designed. In FIG. 3B, the first restoration filter 231 is designed for restoring the out-of-focus image segment 101, and the second restoration filter 232 and the third restoration filter 233 are respectively for restoration of the image segments 102 and 104.

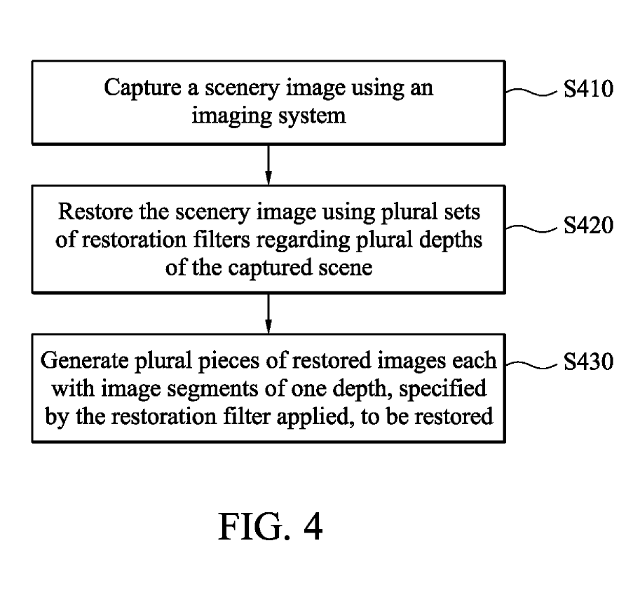

FIG. 4 is a schematic view of a first embodiment of an image restoration method of the disclosure.

A scenery image is captured using an imaging system (step S410). The scenery image is restored using plural sets of restoration filters regarding plural (and different) depths of the captured scene (step S420), to generate plural pieces of restored images each with image segments of one depth, specified by the restoration filter applied, to be restored (step S430).

Note that the restoration filters are designed according to the processing range and the depths to be processed (i.e. D₁˜Dₙ) within the processing range. Generally, the processing range, the depth number (the n value) and the depths D₁˜Dₙ are determined based on the specifications of the imaging system (or camera apparatus) or the scene to capture. For example, when the disclosure is applied to a video camera, the processing range can be 50 cm to 3 m and n can be 5.

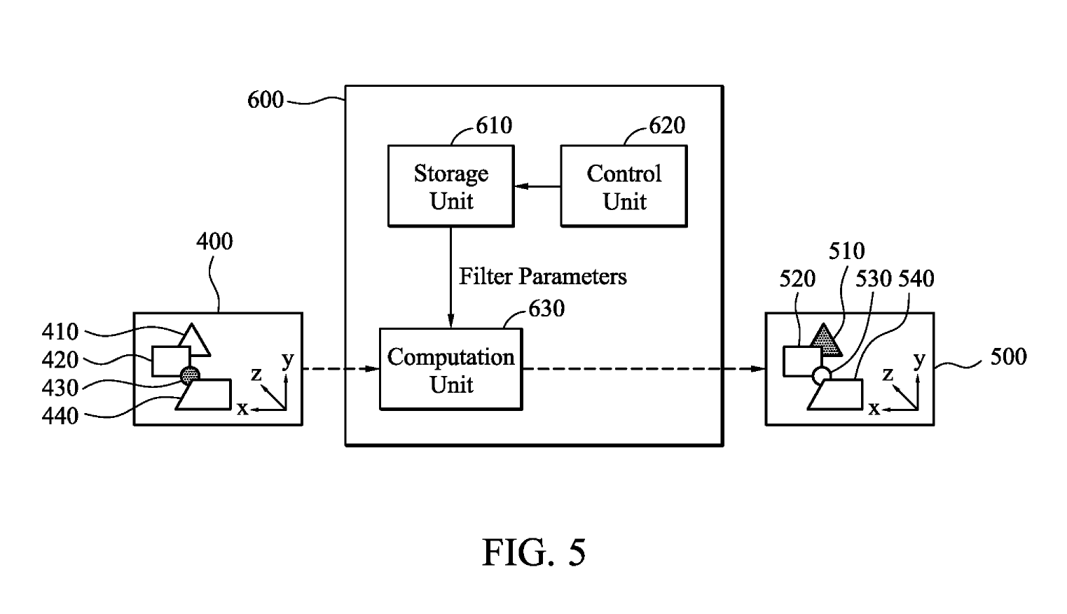

FIG. 5 is a schematic view of a second embodiment of an image restoration apparatus of the disclosure.

An image 400 captured by an imaging system (not shown) comprises image segments 410, 420, 430, and 440 respectively located at different depths, wherein only the image segment 430 is focused (i.e. located in the focal plane) while the image segments 410, 420, and 440 are defocused and blurred (i.e. located in the out-of-focus planes). The image restoration apparatus 600 comprises a storage unit 610, a control unit 620, and a computation unit 630. The storage unit 610 internally stores three sets of filter parameters used to restore the image segments located in the three corresponding depths for the imaging system. For simplification, the out-of-focus object 410 is originally located at one of the three depths, which is capable of being restored using one of the sets of filter parameters corresponding to the selected depth.

The control unit 620 is configured to select or switch a set of filter parameters to be loaded into the computation unit 630 for selecting one of the depths to be restored in the image 400, i.e., simulating to adjust the focus plane to a target object distance specified by the selected filter parameters. The computation unit 630 loads, from the storage unit 610, a set of filter parameters selected by the control unit 620 and performs a restoration processing to the image 400 according to the selected filter parameters. That is to say, the computation unit 630 performs the restoration processing to the image 400 and generates a restored image 500, of which the image segment 510 is the restored image segment of image segment 410.

Note that the imaging system (not shown) can be a surveillance camera or an image capturing device, used for capturing a scenery image like the image 400. Further, the image restoration planes can be selected using the control unit 620 to simulate adjustment of the focal plane.

Note that the conditions for selecting or switching of filter parameters is not the technical feature of the disclosure and they can be implemented using prior methods, so details thereof are not described herein. Further, each set of filter parameters may comprise at least one coefficient.

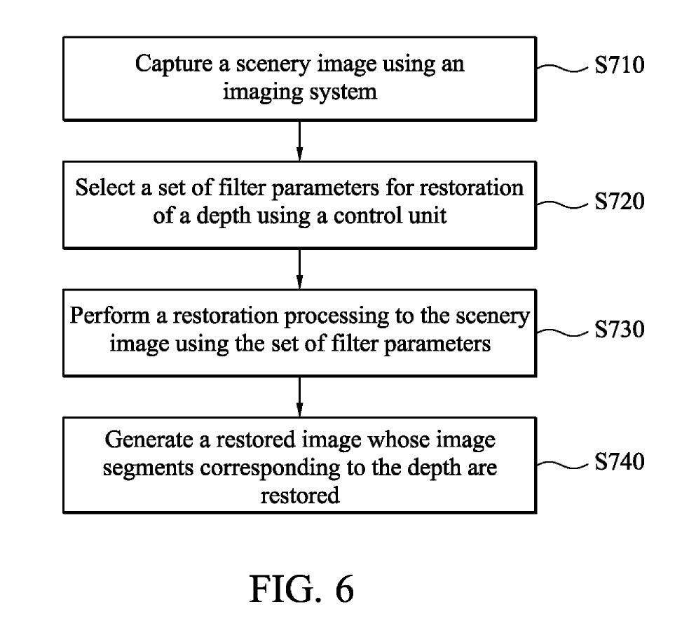

FIG. 6 is a schematic view of a second embodiment of an image restoration method of the disclosure.

A scenery image is captured using an imaging system (step S710). A set of filter parameters for restoration of a depth is selected using a control unit (step S720) and used to perform a restoration processing to the scenery image (step S730). Thus, a restored image is generated whose image segments corresponding to the depth are restored (step S740).

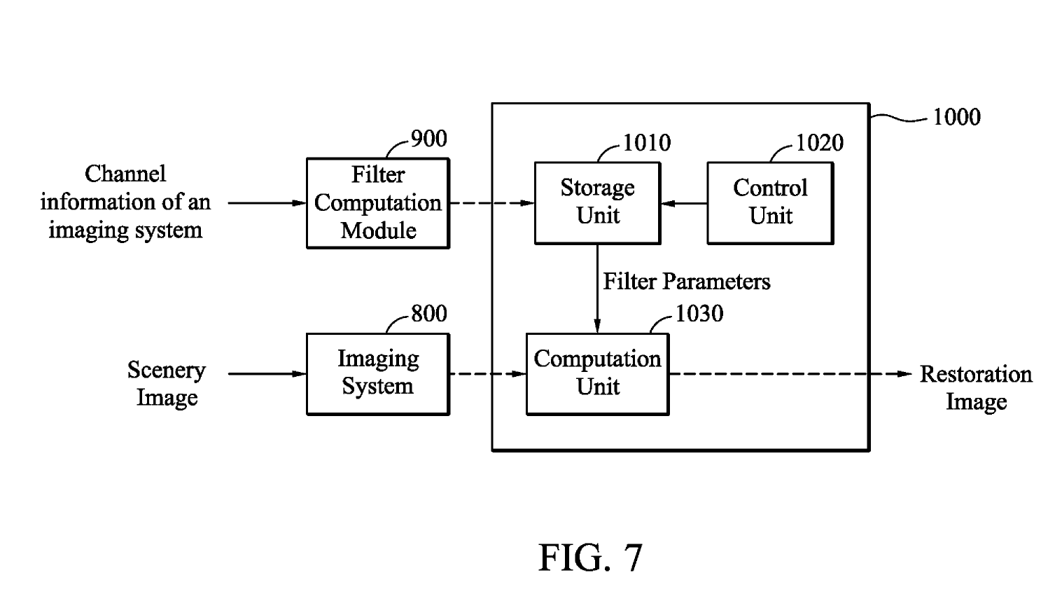

FIG. 7 is a schematic view of a third embodiment of an image restoration apparatus of the disclosure.

An imaging system 800 extracts a scenery image. A filter computation module 900 calculates a plurality of sets of filter parameters based on the channel information of the imaging system 800. The channel information may comprise specifications of optical lens (the PSF or OTF, for example), specifications of a sensor (the resolution or the size of pixels, for example), and so on. The filter parameters can be designed using, but is not limited to, the Wiener method, the Minimum Mean Square Error (MMSE) method, the Iterative Least Mean Square (ILMS) method, the Minimum Distance (MD) method, the Maximum Likelihood (ML) method or the Maximum Entropy (ME) method.

The image restoration apparatus 1000 comprises a storage unit 1010, a control unit 1020, and a computation unit 1030. The sets of filter parameters calculated by the filter computation module 900 are stored in the storage unit 1010 and used to restore the scenery image captured by the imaging system 800. The control unit 1020 is configured to select or switch from the storage unit 1010, a set of the filter parameters to be loaded into the computation unit 1030, for selecting a depth of the captured scenery image to be restored. The computation unit 1030 loads, from the storage unit 1010, the set of the filter parameters selected by the control unit 1020 and performs a restoration processing to the scenery image captured by the image 800 according to the selected filter parameters.

Note that the conditions for selecting or switching of filter parameters is not the technical feature of the disclosure and they can be implemented using prior methods, so details thereof are not described herein. Further, each set of filter parameters may comprise at least one coefficient.

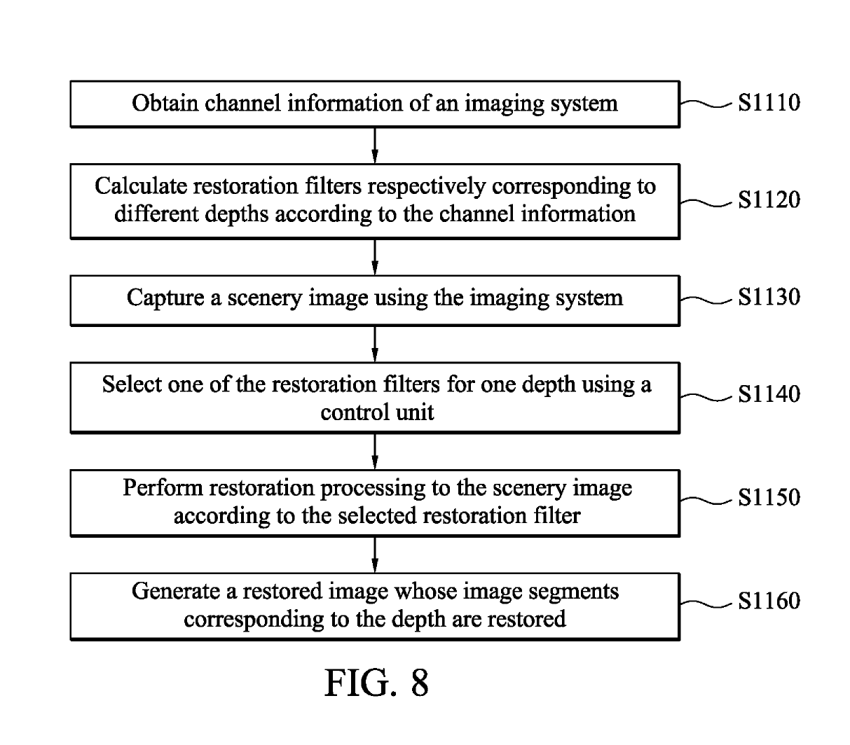

FIG. 8 is a schematic view of a third embodiment of an image restoration method of the disclosure.

Channel information of an imaging system is obtained (step S1110). Restoration filters respectively corresponding to different depths of a scenery image are calculated and generated according to the channel information (step S1120). Next, a scenery image is captured using the imaging system (step S1130), and one of the restoration filters (each containing a set of filter parameters) for one depth is selected using a control unit (step S1140) and used to perform restoration processing to the scenery image according to the selected restoration filter (step S1150). Thus, a restored image is generated whose image segments corresponding to the depth are restored (step S1160).

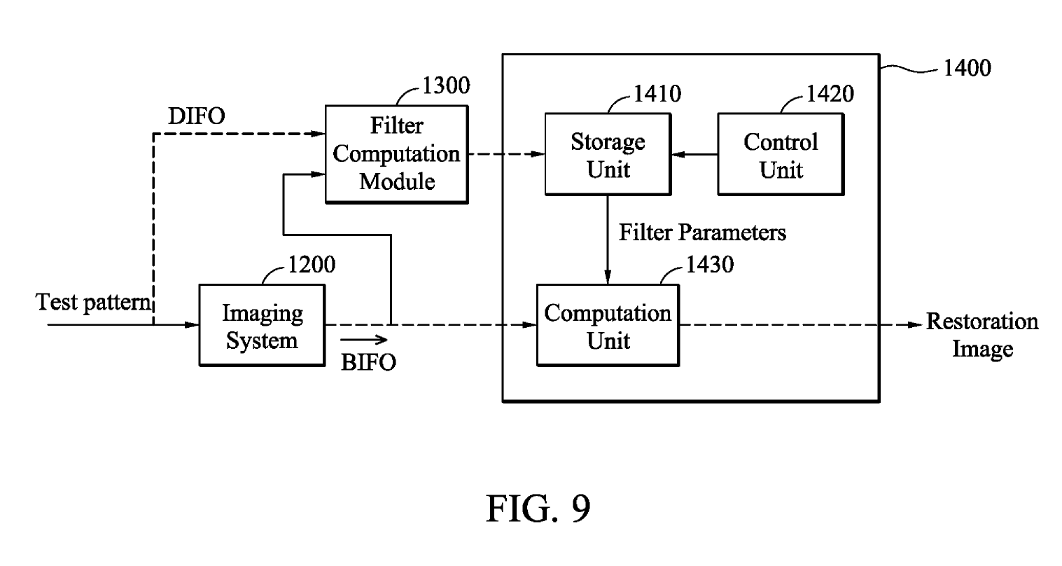

FIG. 9 is a schematic view of a fourth embodiment of an image restoration apparatus of the disclosure.

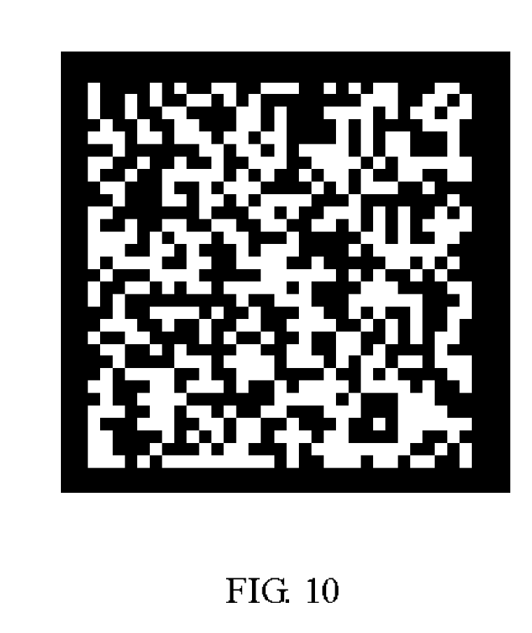

In some situations, channel information of an optical lens or an imaging system cannot be obtained such that the filter parameters cannot be calculated accordingly. Thus, this embodiment takes a test pattern (as shown in FIG. 10) as an input of an imaging system 1200. The test pattern is captured using the imaging system 1200 to obtain blur image information BIFO. A filter computation module 1300 retrieves the digital image information DIFO of the test pattern. The filter computation module 1300 calculates a set of filter parameters, for a depth, based on the MMSE method according to the blur image information BIFO and the digital image information DIFO, so that the similarity between the digital image information DIFO and restored image information of the blur image information BIFO using the set of filter parameters can be maximized. The test pattern can be captured under different object distances with size modification according to the magnification ratio of the imaging system with respect to the object distances. The process described above to design a set of filter parameters for one depth can be repeated for multiple depths to obtain multiple sets of filter parameters respectively. The multiple sets of filter parameters are provided to the image restoration apparatus 1400 for processing captured scenery images by the imaging system 1200.

Note that, in this embodiment, the capture of the test pattern can use only one chart or different charts with size or spatial modifications for different object distances to obtain the information for calculating the sets of filter parameters.

Note that the test pattern captured by the imaging system can be displayed on a computer screen or printed on a paper. The digital image information DIFO and the blur image information BIFO are generally both digital image information.

The image restoration apparatus 1400 comprises a storage unit 1410, a control unit 1420, and a computation unit 1430. The sets of filter parameters calculated by the filter computation module 1300 are stored in the storage unit 1410 and used to restore scenery images captured by the imaging system 1200.

The imaging system captures a scenery image. The control unit 1420 is configured to select or switch, from the storage unit 1410, a set of filter parameters to be loaded into the computation unit 1430 for selecting a depth of the scenery image to be processed. The computation unit 1430 loads, from the storage unit 1410, the set of the filter parameters selected by the control unit 1420 and performs a restoration processing to the scenery image captured by the image system 1200 according to the selected set of filter parameter.

In this embodiment, the restoration filter is designed using, but is not limited to, the MMSE method. To design a filter related to the imaging system, a test pattern composed of pseudo-random data (as shown in FIG. 10) is placed at a preset object distance and is captured using the imaging system. The color of the test pattern is black and white, gray, or multi-colored. Further, the test pattern is composed of pseudo-random data, lines, geometric patterns or characters. Further, the shape of the test pattern comprises dots, lines, a square, a circle, a polygon, or other geometric shapes. Digital image information DIFO of the test pattern image and the blur image information BIFO outputted by the imaging system 1200 are used to calculate the MMSE restoration filter.

Assume that the image captured by the imaging system represents B, the restoration filter represents W, and an output image (the restored image) of the filter represents Î which can also serve as an estimation value of the original image I. Thus using convolution, the restoration processing can be represented as:

$$\hat{I} ( i , j ) = {\sum }_{k = 1}^{m} {\sum }_{l = 1}^{n} B ( i + k , j + 1 ) W ( k , l ) , \qquad ( 1 )$$

where the variables in the brackets (such as i and j) represent row and column indexes of an image and the variables m and n represent the dimensions of the restoration filter W.

The described output image can be a black and white, gray, and color image while the pixel values thereof can be the values for a channel under RGB space and can also be the values for a channel under the YUV, Luv, or YIQ color space. This embodiment defines a performance index J to calculate the MMSE restoration filter, wherein the performance index J is represented as:

J=E{(I(i,j)−\hat{I}(i,j))²}=E{I²(i,j)}−2E{I(i,j)\hat{I}(i,j)}+E{Î²(i,j)} (2),

where equation (2) represents the mean square error of the two images.

Substituting equation (1) into equation (2) and then take partial differentiation with respect to W(k,l) to generate:

$$\frac{\partial J}{\partial W ( k , l )} = 2 E \{ I ( i , j ) B ( i + k , j + l ) \} + 2 {\sum }_{p = 1}^{m} {\sum }_{q = 1}^{n} E \{ B ( i + p , j + q ) B ( i + k , j + l ) \} W ( p , q ) , \qquad ( 3 )$$

where k represent integers from 1 to m and l represents integers from 1 to n.

Meanwhile, if an autocorrelation R_{BB} and a cross-correlation R_{IB} are defined as follows:

R_{BB}(k−p,l−q)=E{B(i+p,j+q)B(i+k,j+l)} (4), and

R_{IB}(k,l)=E{I(i,j)B(i+k,j+l)} (5),

and then equation (3) can be modified as:

$$\frac{\partial J}{\partial W ( k , l )} = - 2 {R}_{IB} ( k , l ) + 2 {\sum }_{p = 1}^{m} {\sum }_{q = 1}^{n} {R}_{BB} ( k - p , l - q ) W ( p , q ) , \qquad ( 6 )$$

where k represents 1˜m and l represents 1˜n.

Assume that equation (6) equals 0 for calculating the coefficient of the MMSE restoration filter W and then it gives:

$${R}_{IB} ( k , l ) = {\sum }_{p = 1}^{m} {\sum }_{q = 1}^{n} {R}_{BB} ( k - p , l - q ) W ( p , q ) , \qquad ( 7 )$$

where k represents 1˜m and l represents 1˜n. Equation (7) can be further simplified as:

r̅_{IB}=R_{BB} w̅ (8),

where r̅_{IB} and w̅ are vectors composed of R_{IB} and W respectively.

Thus, the computation result of the restoration filter W can be obtained as:

w̅=R_{BB}⁻¹ r̅_{IB} (9).

Finally, the autocorrelation R_{BB} and the cross-correlation R_{IB} are calculated using the digital image information of the test pattern and the blur image information of the test pattern obtained by the imaging system, thus calculating the restoration filter w̅ or W.

The computation of the MMSE restoration filter is only an example of numerical methods implemented in the disclosure and is not to be limitative. Thus, those skilled in the art can use other numerical methods such as Iterative Least Mean Square (ILMS), Minimum Distance (MD), Maximum Likelihood (ML), or Maximum Entropy (ME) to calculate restoration filters for the images captured by the imaging system.

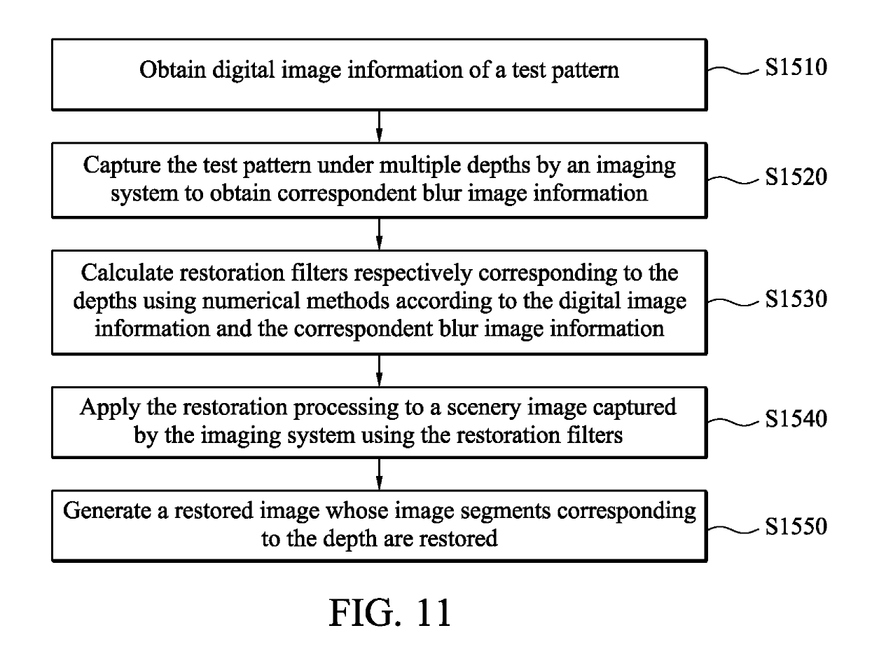

FIG. 11 is a schematic view of a fourth embodiment of an image restoration method of the disclosure.

First, the digital image information of a test pattern is obtained (step S1510). Next, the test pattern is captured under multiple depths by an imaging system to obtain correspondent blur image information (step S1520). Restoration filters respectively corresponding to the depths are calculated using numerical methods according to the digital image information and the correspondent blur image information (step S1530). Next, the restoration processing described in the embodiments of the disclosure is applied to a scenery image captured by the imaging system using the restoration filters (step S1540). Thus, a restored image is generated whose image segments corresponding to the depth are restored (step S1550).

Note that the digital image information and the blur image information is gray format or represented by an RGB, YUV, Luv or YIQ color format.

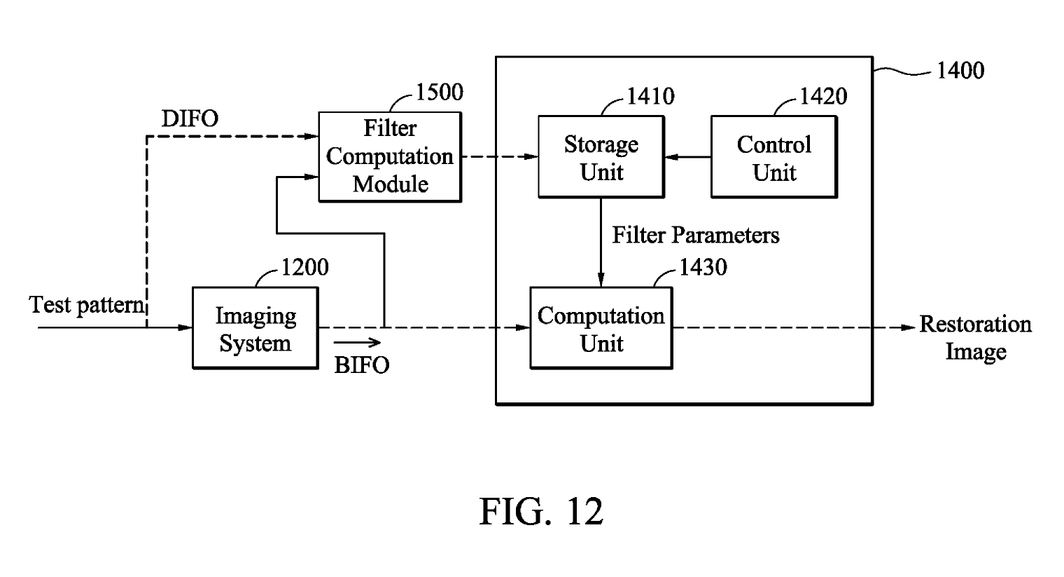

FIG. 12 is a schematic view of a fifth embodiment of an image restoration apparatus of the disclosure.

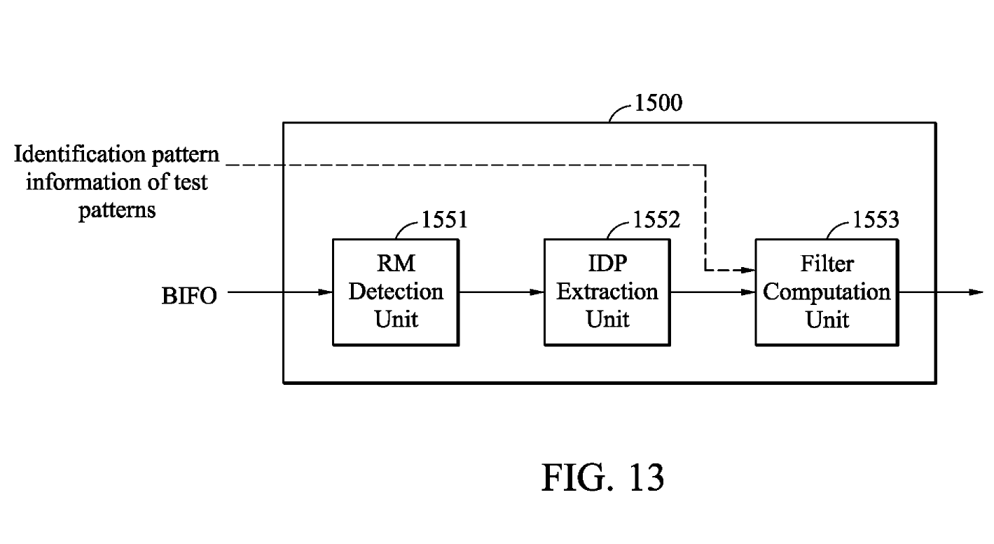

The difference between the image restoration apparatus of the fifth embodiment and that of the fourth embodiment is the architecture of the filter computation module 1500. FIG. 13 is a schematic view of the fifth embodiment of a filter computation module of the disclosure. The filter computation module 1500 comprises a reference mark (RM) detection unit 1551, an identification pattern (IDP) extraction unit 1552, and a filter calculation unit 1553.

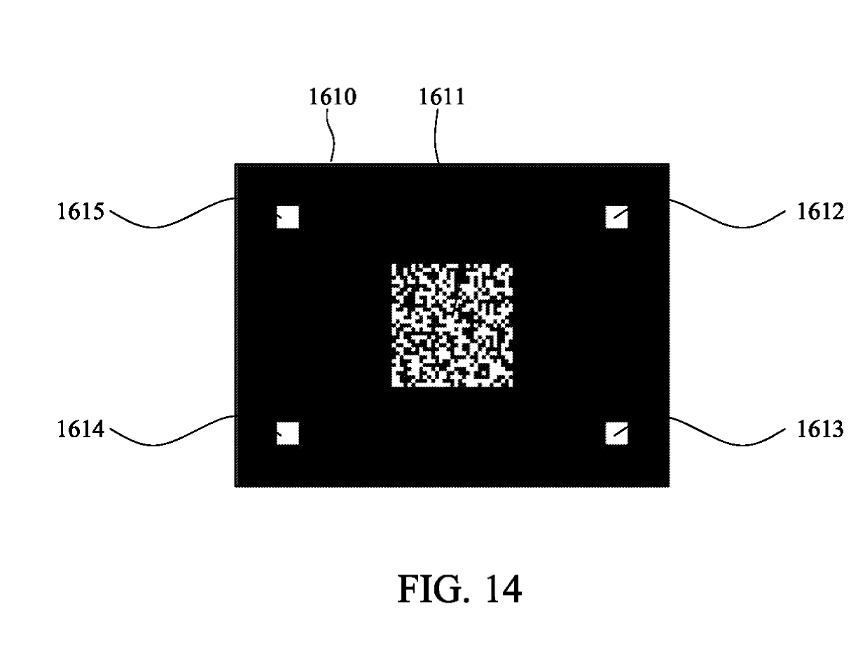

FIG. 14 is a schematic view of the fifth embodiment of a test pattern 1610 in the fifth embodiment of the disclosure, in which the symbol 1611 represents the identification pattern, and the symbols 1612, 1613, 1614, and 1615 represent the reference marks. The imaging system 1200 captures the test pattern 1610 located at a depth and transmits blur image information BIFO of the test pattern to the filter computation module 1500. The RM detection unit 1551 of the filter computation module 1500 first detects the reference marks within the blur image information BIFO to obtain reference position information of the reference marks, and then transmits the reference position information and the blur image information BIFO to the IDP extraction unit 1552. The IDP extraction unit 1552 extracts the identification pattern information from the blur image information BIFO and provides it to the filter calculation unit 1553. The filter computation unit 1553 calculates a set of filter parameters for the depth according to the identification pattern information in the test pattern 1610 and that of the blur image information BIFO received from the IDP extraction unit 1552. The process described above to design a set of filter parameters for one depth can be repeated for multiple depths to obtain multiple sets of filter parameters respectively. The computation of the sets of filter parameters in the fifth embodiment is similar to that described in the fourth embodiment. Therefore, the architecture of the filter computation module 1500 automatizes the design of filter parameters.

Note that the shape of the identification pattern 1611 comprises dots, lines, a square, a circle, a polygon, or other geometric shapes. The identification pattern 1611 is composed of pseudo-random data, lines, geometric patterns or character. The color of the identification pattern 1611 is black and white, gray, or multi-colored.

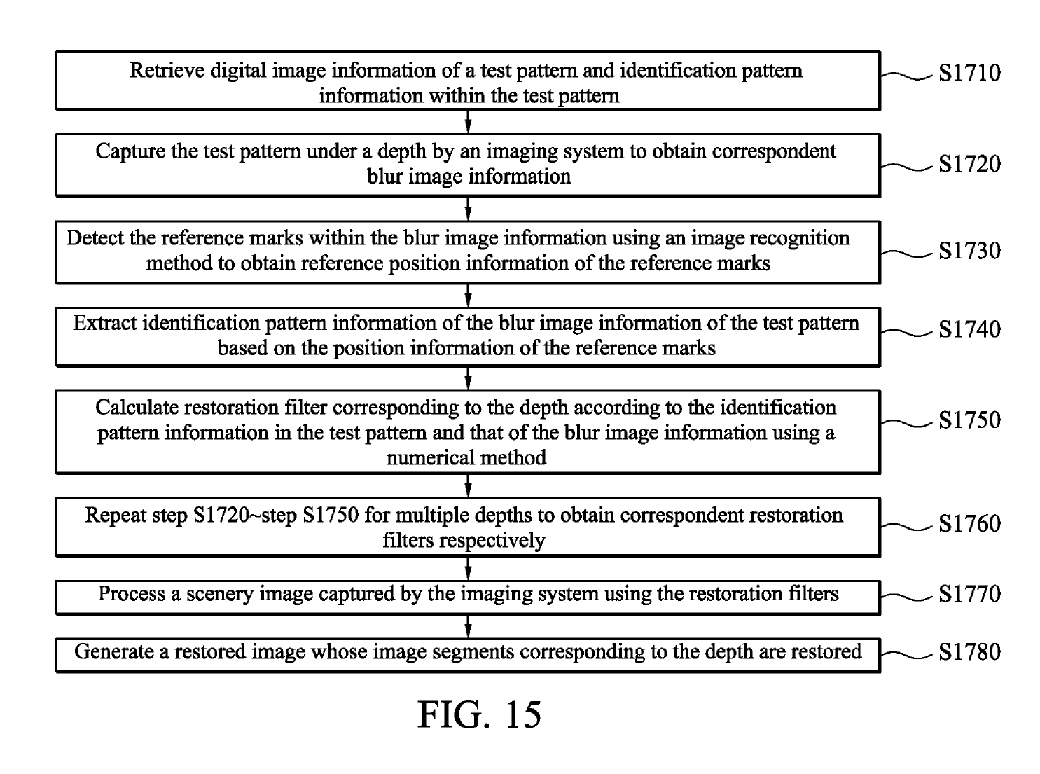

FIG. 15 is a schematic view of a fifth embodiment of an image restoration method of the disclosure.

Digital image information of a test pattern and identification pattern information within the test pattern are retrieved (step S1710). Next, the test pattern is captured under a depth by an imaging system to obtain correspondent blur image information (step S1720). An image recognition method is implemented to detect the reference marks within the blur image information to obtain reference position information of the reference marks (step S1730).

Next, identification pattern information of the blur image information of the test pattern is extracted based on the position information of the reference marks (step S1740). Next, restoration filter corresponding to the depth is calculated according to the identification pattern information in the test pattern and that of the blur image information using a numerical method (step S1750). The process described above to design a restoration filter for one depth (step S1720˜step S1750) can be repeated for multiple depths to obtain multiple restoration filters respectively (step S1760). Next, a scenery image captured by the imaging system is processed using the restoration filters (step S1770). Thus, a restored image is generated whose image segments corresponding to the depth are restored (step S1780).

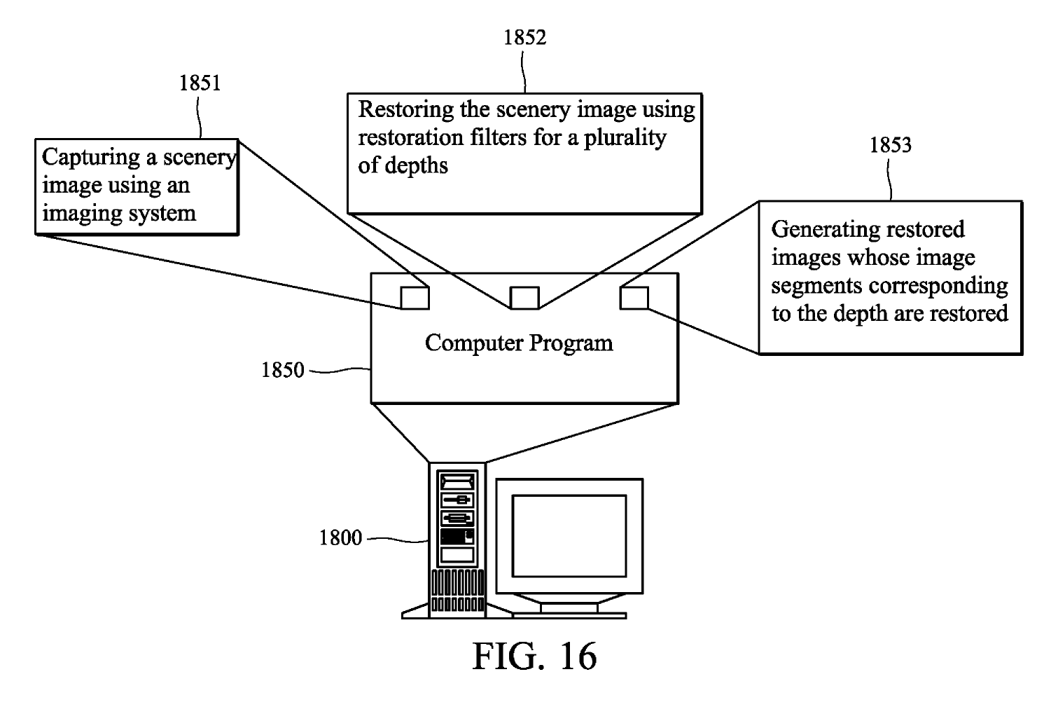

FIG. 16 is a schematic view of a computer-readable medium of the disclosure. The computer-readable medium 1800 stores a computer program 1850 which is loaded in a computer system and performs an image restoration method. The computer program 1850 comprises a program logic 1851 capturing a scenery image using an imaging system, a program logic 1852 restoring the scenery image using restoration filters for a plurality of depths, and a program logic 1853 generating restored images whose image segments corresponding to the depth are restored.

Note that FIG. 16 only discloses the computer program of the first embodiment but, in practice, the disclosure further provides computer programs of the second to fifth embodiments, which is not further described for simplification.

Note that the storage unit, the computation unit, and the control unit can be implemented by hardware or software. If implemented by hardware, the storage unit, the computation unit, or the control unit can be a circuit, chip or any other hardware components capable of performing storage/computation/control functions.

The features of embodiments of the image restoration method and apparatus comprise: (1) no moving parts or moving mechanisms are required and can adjust the clear image plane/depth of the captured scenery image; (2) only one image need to be captured using the imaging system and multiple restored images corresponding to different depths can be generated; (3) easy to implement the method in software or hardware; (4) parallel computation for restoration processing of multiple depth to a captured image; and (5) applicable to conventional cameras.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the disclosure has been described by way of example and in terms of the embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image restoration method configured to restore an image captured by an imaging system, comprising:
capturing a scenery image by the imaging system; and
applying a restoration processing to the scenery image using a plurality of restoration filters respectively corresponding to a plurality of depths, to generate a plurality of restored images respectively corresponding to the depths.

2. The image restoration method as claimed in claim 1, further comprising selecting an out-of-focus plane corresponding to one of the depths from the scenery image, and applying a restoration processing to the out-of-focus plane using a restoration filter corresponding to the one of depth, to generate the restored image corresponding to the out-of-focus plane.

3. The image restoration method as claimed in claim 1, further comprising selecting a restoration filter corresponding to one of the depths from the scenery image and applying a restoration processing to the out-of-focus plane using the restoration filter to generate a restored image according to the depth corresponding to the out-of-focus plane.

4. The image restoration method as claimed in claim 1, wherein the restoration filters are calculated according to channel information corresponding to different depths for the imaging system.

5. The image restoration method as claimed in claim 1, wherein the restoration filters are calculated according to a processing range of the scenery image and a number of the depths to be processed within the processing range.

6. The image restoration method as claimed in claim 1, wherein the scenery image is a two-dimensional image.

7. An image restoration apparatus configured to apply a restoration processing to a scenery image captured by an imaging system, comprising:
a storage unit, configured to store a plurality of sets of filter parameters respectively corresponding to different depths; and
at least one computation unit, coupled to the storage unit and configured to load the sets of the filter parameters from the storage unit and apply a restoration processing to the scenery image respectively according to the sets of the filter parameters to generate a plurality of restored images respectively corresponding to different depths.

8. The image restoration apparatus as claimed in claim 7, further comprising a control unit configured to select an out-of-focus plane corresponding to one of the depths from the scenery image, and wherein the computation unit applies a restoration processing to the out-of-focus plane using a set of filter parameters corresponding to the one of the depth, to generate the restored image corresponding to the out-of-focus plane.

9. The image restoration apparatus as claimed in claim 7, further comprising a control unit, wherein the control unit is configured to select a set of filter parameters corresponding to one of the depths from the scenery image and the computation unit performs a restoration processing using the set of filter parameters to generate a restored image corresponding to the depth.

10. The image restoration apparatus as claimed in claim 7, wherein the sets of the filter parameters are calculated according to the optical characteristics of the imaging system.

11. The image restoration apparatus as claimed in claim 7, wherein the sets of the filter parameters are calculated according to the depths of the scenery image to be processed.

12. The image restoration apparatus as claimed in claim 7, wherein the scenery image is a two-dimensional image.

13. An image restoration method used in an image restoration apparatus and configured to restore an image captured by an imaging system, comprising:
retrieving channel information of the imaging system;
calculating a plurality of restoration filters respectively corresponding to a plurality of depths according to the channel information;
capturing a scenery image by the imaging system; and
applying a restoration processing to the scenery image using the restoration filters to generate a plurality of restored images respectively corresponding to the depths.

14. The image restoration method as claimed in claim 13, further comprising selecting an out-of-focus plane corresponding to one of the depths from the scenery image, and applying a restoration processing to the out-of-focus plane using a restoration filter corresponding to the one of the depth, to generate the restored image corresponding to the out-of-focus plane.

15. The image restoration method as claimed in claim 13, wherein the channel information comprises a point spread function (PSF) or an optical transfer function (OTF).

16. The image restoration method as claimed in claim 13, wherein the scenery image is a two-dimensional image.

17. An image restoration apparatus configured to apply a restoration processing to a scenery image captured by an imaging system, comprising:
a filter computation module, configured to capture channel information of the imaging system and calculate a plurality of sets of filter parameters respectively corresponding different depths according to the channel information;
a storage unit, coupled to the filter computation module and configured to store the sets of the filter parameters; and
at least one computation unit, coupled to the storage unit, configured to load the sets of the filter parameters corresponding to the depths from the storage unit and apply a restoration processing to the scenery image according to the sets of the filter parameters to generate a plurality of restored images respectively corresponding to the depths.

18. The image restoration apparatus as claimed in claim 17, further comprising a control unit, configured to select an out-of-focus plane corresponding to one of the depths from the scenery image, and wherein the computation unit applies a restoration processing to the out-of-focus plane using one of the set of the filter parameters corresponding to the one of the depth, to generate the restored image corresponding to the out-of-focus plane.

19. The image restoration apparatus as claimed in claim 17, wherein the channel information comprises a point spread function (PSF) or an optical transfer function (OTF).

20. The image restoration apparatus as claimed in claim 17, wherein the scenery image is a two-dimensional image.

21. An image restoration method used in an image restoration apparatus and configured to restore an image captured by an imaging system, comprising:
retrieving first image information of a test pattern;
retrieving plural pieces of second image information generated by capturing the test pattern, using the imaging system, under a plurality of depths;
calculating a plurality of restoration filters according to the first image information and the pieces of second image information;
capturing a scenery image by the imaging system; and
applying a restoration processing to the scenery image using the restoration filters to generate a plurality of restored images respectively corresponding to the depths.

22. The image restoration method as claimed in claim 21, wherein a numerical method is used to calculate the restoration filters respectively corresponding to the depths to obtain a maximum similarity between each of the pieces of second image information and the first image information.

23. The image restoration method as claimed in claim 22, wherein the numerical method is a Wiener Method, a Minimum Mean Square Error (MMSE) method, an Iterative Least Mean Square (ILMS) method, a Minimum Distance (MD) method, a Maximum Likelihood (ML) method or a Maximum Entropy (ME) method.

24. The image restoration method as claimed in claim 21, wherein the color of the test pattern is black-and-white, gray level, or multi-colored.

25. The image restoration method as claimed in claim 21, wherein the test pattern is composed of pseudo-random data, lines, geometric patterns or characters.

26. The image restoration method as claimed in claim 21, wherein the test pattern is a gray-level image or a color image with the RGB, YUV, Luv, or YIQ format.

27. The image restoration method as claimed in claim 21, further comprising selecting an out-of-focus plane corresponding to one of the depths from the scenery image, and applying a restoration processing to the out-of-focus plane using a restoration filter corresponding to the one of the depth, to generate a restored image corresponding to the out-of-focus plane.

28. The image restoration method as claimed in claim 21, wherein the scenery image is a two-dimensional image.

29. An image restoration apparatus configured to apply a restoration processing to a scenery image captured by an imaging system, comprising:
a filter computation module, configured to capture original first image information of a test pattern, capture plural pieces of second image information generated by capturing the test pattern, using the imaging system, under a plurality of depths, and calculate a plurality of sets of filter parameters respectively corresponding to the depths according to the first image information and the pieces of second image information;
a storage unit, coupled to the filter computation module and configured to store the sets of the filter parameters; and
at least one computation unit, coupled to the storage unit and configured to load the sets of the filter parameters from the storage unit and apply a restoration processing to the scenery image according to the sets of the filter parameters to generate a plurality of restored images respectively corresponding to the depths.

30. The image restoration apparatus as claimed in claim 29, wherein the filter computation module calculates the sets of the filter parameters respectively corresponding to the depths using a numerical method, to obtain a maximum similarity between each of the pieces of second image information and the first image information.

31. The image restoration apparatus as claimed in claim 30, wherein the numerical method is a Wiener Method, a Minimum Mean Square Error (MMSE) method, an Iterative Least Mean Square (ILMS) method, a Minimum Distance (MD) method, a Maximum Likelihood (ML) method or a Maximum Entropy (ME) method.

32. The image restoration apparatus as claimed in claim 29, further comprising a control unit, configured to select an out-of-focus plane corresponding to one of the depths from the scenery image, and wherein the computation unit applies the restoration processing to the out-of-focus plane using the set of the filter parameters corresponding to the depth, to generate the restored image corresponding to the out-of-focus plane.

33. The image restoration apparatus as claimed in claim 29, wherein the filter computation module further comprises:
a reference mark detection unit, configured to detect reference marks of the test pattern for generating reference position information;
an identification pattern extraction unit, coupled to the reference mark detection unit and configured to extract a plurality of identification patterns from the pieces of second image information according to the reference position information and the pieces of second image information; and
a filter computation unit, coupled to the identification pattern extraction unit and configured to calculate the sets of the filter parameters respectively corresponding to the depths based on the identification patterns and the first image information.

34. The image restoration apparatus as claimed in claim 33, wherein the test pattern is black-and-white, gray level, or multi-colored.

35. The image restoration apparatus as claimed in claim 34, wherein the test pattern is composed of pseudo-random data, lines, geometric patterns or characters.

36. The image restoration apparatus as claimed in claim 34, wherein the test pattern is a gray-level image or a color image with the RGB, YUV, Luv, or YIQ format.

37. The image restoration apparatus as claimed in claim 29, wherein the first image information or the pieces of second image information are gray-level images or multi-colored images with the RGB, YUV, Luv, or YIQ format.

38. The image restoration apparatus as claimed in claim 29, wherein the scenery image is a two-dimensional image.

39. A computer-readable medium encoded with computer executable instructions for performing an image restoration method used in an image restoration apparatus and configured to restore an image captured by an imaging system, wherein the computer executable instructions comprise:
capturing a scenery image by the imaging system; and
applying a restoration processing to the scenery image using a plurality of restoration filters respectively corresponding to a plurality of depths, to generate a plurality of restored images respectively corresponding to the depths.

40. The computer-readable medium as claimed in claim 39, wherein before the scenery image is captured from the imaging system, the computer executable instructions further comprise:
retrieving channel information of the imaging system; and
calculating the restoration filters respectively corresponding to the depths according to the channel information.

41. A computer-readable medium encoded with computer executable instructions for performing an image restoration method used in an image restoration apparatus and configured to restore an image captured by an imaging system, wherein the computer executable instructions comprise:
retrieving first image information of a test pattern;
retrieving plural pieces of second image information generated by capturing the test pattern, using the imaging system, under a plurality of depths;
calculating a plurality of restoration filters respectively corresponding to the depths according to the first image information and the pieces of second image information;
capturing a scenery image by the imaging system; and
applying a restoration processing to the scenery image using the restoration filters to generate a plurality of restored images respectively corresponding to the depths.
